(19) United States
(12) Patent Application Publication
(10) Pub. No.: US 2023/0206176 A1
(43) Pub. Date: Jun. 29, 2023

(54) DEMAND AND SUPPLY PLANNING APPARATUS AND DEMAND AND SUPPLY PLANNING METHOD

(71) Applicant: Hitachi, Ltd., Chiyoda-ku, Tokyo (JP)

(72) Inventors: Kenji OYA, Tokyo (JP); Tazu NOMOTO, Tokyo (JP)

(21) Appl. No.: 17/927,962

(22) PCT Filed: May 10, 2021
(86) PCT No.: PCT/JP2021/017733

§ 371 Date: Nov. 28, 2022

(30) Foreign Application Priority Data
Aug. 12, 2020 (JP) 2020-136198

(51) Int. Cl. G06Q 10/0875; G06Q 30/0202

(52) U.S. Cl. CPC G06Q 10/0875; G06Q 30/0202

(57) ABSTRACT

A demand prediction in each planning unit is calculated based on a planning unit of a demand to be prepared by each company constituting a supply chain, and an appropriate supply plan in which each company can adopt necessary and sufficient demand prediction data is output.

A demand and supply planning apparatus includes a supply chain structure extraction unit that specifies a lead time between bases having different business entities in a supply chain structure and supply paths of products and materials of the products, a product configuration extraction unit that extracts a bill of materials of the product, a planning unit calculation unit that calculates a planning unit in which a demand prediction is to be prepared by using any one or a combination of positions of the bases within the supply chain structure, the supply paths, and the bill of materials, a demand prediction calculation unit that calculates the demand prediction for each panning unit calculated by the planning unit calculation unit, a supply plan extraction unit that extracts data to be handled as a supply plan for each base from the demand prediction in accordance with the lead time and the planning unit, and a supply plan communication unit that transmits the extracted supply plan to each base or each business entity.

### TECHNICAL FIELD

The present invention relates to a demand and supply planning apparatus and a demand and supply planning method. The present invention claims priority to Japanese Patent Application No. 2020-136198 filed on Aug. 12, 2020, and the content described in the application is incorporated herein by reference for designated countries where incorporation by reference to documents is permitted.

### BACKGROUND ART

PTL 1 describes that “a prediction value calculation unit 20 contributes to improvement in prediction accuracy of a demand and calculates a prediction value of a future demand based on a past demand record value, a correction information reception unit 22 receives an input of a correction value for correcting the prediction value of the demand, a keyword extraction unit 24 sets, as a keyword, information on a correction basis in association with the correction value, and a reliability calculation unit 30 calculates reliability of the correction value corresponding to the keyword based on the prediction value corrected based on the correction value and the demand record value. a correction reflection unit 32 outputs a keyword corresponding to a correction value input past and reliability of the correction value in association with each other for the correction of the prediction value using the correction value input past”.

### CITATION LIST

### Patent Literature

PTL 1: JP 2017-151731 A

### SUMMARY OF INVENTION

### Technical Problem

In the technique described in PTL 1, a predicted value corresponding to a keyword such as a sales period or the like set as information of the correction basis can be calculated. However, in a company belonging to a supply chain having many hierarchies, there is a point insufficient to perform a demand prediction based on an end customer, excluding the influence of decision-making of a company belonging to a downstream of the company.

An object of the present invention is to calculate a demand prediction in each planning unit based on a planning unit of a demand to be prepared by each company constituting a supply chain and output an appropriate supply plan in which each company can adopt necessary and sufficient demand prediction data.

### Solution to Problem

The present application includes a plurality of means for solving at least a part of the above problems, but examples thereof are as follows. In order to solve the above problem, a demand and supply planning apparatus according to an aspect of the present invention includes a supply chain structure extraction unit that specifies a lead time between bases having different business entities in a supply chain structure and supply paths of products and materials of the products, a product configuration extraction unit that extracts a bill of materials (BOM) of the product, a planning unit calculation unit that calculates a planning unit in which a demand prediction is to be prepared by using any one or a combination of positions of the bases within the supply chain structure, the supply paths, and the bill of materials, a demand prediction calculation unit that calculates the demand prediction for each panning unit calculated by the planning unit calculation unit, a supply plan extraction unit that extracts data to be handled as a supply plan for each base from the demand prediction in accordance with the lead time and the planning unit, and a supply plan communication unit that transmits the extracted supply plan to each base or each business entity.

### Advantageous Effects of Invention

According to the present invention, it is possible to calculate the demand prediction in each planning unit based on the planning unit of the demand to be prepared by each company that can be calculated from the supply chain structure and to output an appropriate supply plan in which each company can adopt necessary and sufficient demand prediction data. Other objects, configurations, and effects will be made apparent in the following descriptions.

### BRIEF DESCRIPTION OF DRAWINGS

FIG. 1 is a diagram illustrating a configuration example of a demand and supply planning apparatus according to an embodiment of the present invention.

FIG. 2 is a diagram illustrating a data structure example of a supply chain structure table.

FIG. 3 is a diagram illustrating a data structure example of a BOM table.

FIG. 4 is a diagram illustrating a data structure example of a sales record data table.

FIG. 5 is a diagram illustrating a hardware configuration example of the demand and supply planning apparatus.

FIG. 6 is a diagram illustrating an example of a flow of demand and supply planning processing.

FIG. 7 is a diagram illustrating an example of a flow of planning unit calculation processing.

FIG. 8 is a diagram illustrating an example of a flow of a handled-item extraction processing.

FIG. 9 is a diagram illustrating an example of a flow of supply lead time calculation processing.

FIG. 10 is a diagram illustrating an example of a supply plan output screen.

### DESCRIPTION OF EMBODIMENTS

Hereinafter, an embodiment of the present invention will be described based on the drawings. Note that, in all the drawings for describing the embodiment, the same members are denoted by the same reference signs in principle, and redundant description thereof will be omitted. Furthermore, in the following embodiment, it goes without saying that constituent elements (including element steps, and the like) thereof are not necessarily essential unless explicitly stated or in principle considered to be essential in principle. Furthermore, it goes without saying that the terms “consisting of A”, “formed of A”, “having A”, and “including A” do not exclude other elements except for a case where only the element is specifically stated. Similarly, in the following embodiment, when shapes, positional relationships, and the like of the constituent elements are referred to as, the shapes or the like thereof are considered as substantially approximating or being similar to actual shapes or the like except for a case where the shapes or the like are particularly specified, a case where the shapes or the like are not obviously actual shapes or the like in principle.

In a supply chain of the related art, for example, when a demand prediction of a manufacturer company is obtained, the demand prediction is calculated based on an order from a distributor in many cases. However, a risk or a sales target uniquely considered by the distributor is added to the order in most cases. When a demand prediction of a manufacturer company is performed based on an order from a distributor who tends to perform many orders by overestimating a risk or a distributor who prepares distribution and sales plans larger than sales power, the demand prediction is performed under a misrecognition situation where there may be a demand larger than an actual demand.

In addition, JP 2015-14911 A discloses a technique in which “there is provided a material ordering amount calculation system capable of optimizing inventory and not requiring holding excessive inventory and the component ordering amount calculation system includes means for designating demand prediction parameters (replenishment rate, procurement rate, contract rate, demand prediction method, record acquisition period, unit period, and index) for each material type, calculating a demand prediction and a required amount of a replenishment center and a replenishment base by using the parameters, comparing demand prediction values with records for each material type, and applying (automatically updating) an optimum demand prediction method”.

In this technique, for example, it is possible to stepwisely calculate a demand prediction of an upstream company of the supply chain based on the demand prediction for each store that sells the materials to the end customer. However, a demand prediction of a material vendor also takes into consideration a supply lead time from the material supply to the product sales, that is, the demand is calculated based on a future demand prediction for each store. It is difficult to accurately predict future demand for each store, and it is more difficult for a company belonging to an upstream of the supply chain to perform the supply corresponding to the demand of the end customer. Thus, shortage or excess inventory occurs.

Therefore, the present invention provides an apparatus and a method for calculating a demand prediction in each planning unit based on a planning unit of a demand to be prepared by each company, which can be calculated from a supply chain structure and outputting an appropriate supply plan in which each company adopts necessary and sufficient demand prediction data. For example, there are provided a demand and supply planning apparatus and a method thereof that calculate a supply plan in a material manufacturer based on a demand prediction obtained by summing all end products requiring the materials and calculates a supply plan in a store based on a demand prediction based on a purchase record in the store.

Note that, in the present embodiment, the base constituting the supply chain structure includes any one or a combination of one or a plurality of factories that manufactures the products by using the materials, one or a plurality of suppliers that supplies the products to any one of the factories, and one or a plurality of real stores or virtual stores that sells the products to an end customer. Alternatively, the present invention is not limited thereto, and includes all of those having a supply chain structure forming a distribution network of products.

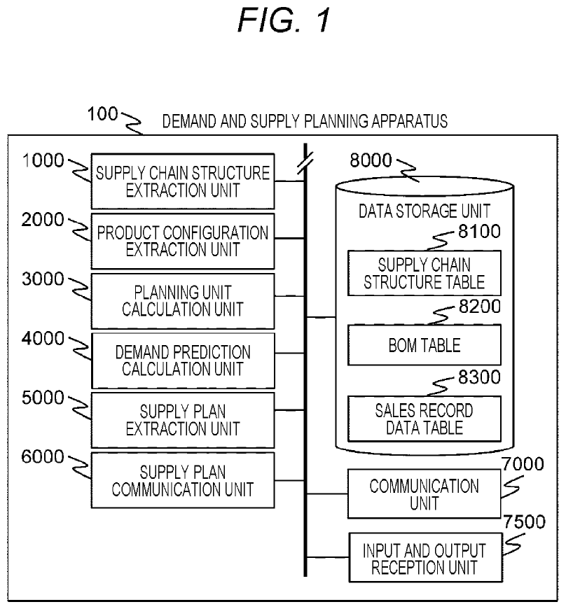

FIG. 1 is a block diagram illustrating a configuration example of a demand and supply planning apparatus according to the present embodiment. A demand and supply planning apparatus 100 includes, as processors, a supply chain structure extraction unit 1000, a product configuration extraction unit 2000, a planning unit calculation unit 3000, a demand prediction calculation unit 4000, a supply plan extraction unit 5000, and a supply plan communication unit 6000, and further includes a communication unit 7000, an input and output reception unit 7500, and a data storage unit 8000.

The supply chain structure extraction unit 1000 acquires a transportation lead time between companies, a supply path of materials and products, and information of companies that perform material production and product assembly via communication with companies constituting a supply chain provided by the communication unit 7000. In other words, it can be said that the supply chain structure extraction unit 1000 specifies a lead time between different bases of business entities and a supply path of products and materials thereof in a supply chain structure.

The product configuration extraction unit 2000 acquires a bill of materials (BOM) information of materials constituting a product of which supply and demand is to be predicted via communication with the company constituting the supply chain provided by the communication unit 7000.

The planning unit calculation unit 3000 calculates a planning unit of a supply plan required by each company by using information acquired by the supply chain structure extraction unit 1000 and the product configuration extraction unit 2000. Specifically, the planning unit calculation unit 3000 calculates a planning unit for which a demand prediction is to be prepared by using at least one or a combination of a position of a base included in the supply chain structure within the supply chain structure, a supply path, and a material configuration (bill of materials). For example, the planning unit calculation unit 3000 specifies a market range formed by tracing back a supply path starting from a base that sells products to an end customer in the supply chain structure by using the combination of the position of the base within the supply chain structure, the supply path, and the material configuration, and calculates planning units in accordance with a predicted adoption period specified by using the market range, a set of products supplied by the base that sells the product to the end customer, and the supply chain structure.

The demand prediction calculation unit 4000 calculates a demand prediction for each of the planning units calculated by the planning unit calculation unit 3000 by using sales record information acquired via communication with the company that sells the product to the end customer provided by the communication unit 7000. Specifically, the demand prediction calculation unit 4000 performs a demand prediction by using sales records in a real store and a virtual store for each planning unit.

The supply plan extraction unit 5000 obtains a range of demand prediction values to be adopted by each company by using supply lead time information from the end customer to each company which is acquired by the supply chain structure extraction unit 1000 and planning unit information of a supply plan required by each company which is acquired by the planning unit calculation unit 3000, and extracts the demand prediction value as the supply plan according to the obtained range.

The supply plan communication unit 6000 transmits the supply plan of each company extracted by the supply plan extraction unit 5000 to the base constituting the supply chain or each company which is the business entity thereof via the communication unit 7000.

Through communication with other devices via a network, the communication unit 7000 takes in various kinds of master information, acquires supply lead time information between companies, acquires supply path information of materials and products, acquires production base information of materials and products, acquires information on a bill of materials, acquires sales record information, provides a screen for outputting a processing result, and provides the processing result to each company. Note that this network is, for example, any one or a combination of a local area network (LAN), a wide area network (WAN), a virtual private network (VPN), a communication network using a general public line such as the Internet partially or entirely, a mobile phone communication network, and the like. Note that the network may be a wireless communication network such as Wi-Fi (registered trademark) or 5G (Generation).

The input and output reception unit 7500 receives an input from a user by using a mouse, a keyboard, a touch panel, or the like, and controls a screen output by a display, a printer, or the like.

The data storage unit 8000 retains various kinds of master information, supply lead time information between companies, supply path information of materials and products, production base information of materials and products, information on a bill of materials, and sales record information. Specifically, the data storage unit 8000 includes a supply chain structure table 8100, a BOM table 8200, and a sales record data table 8300.

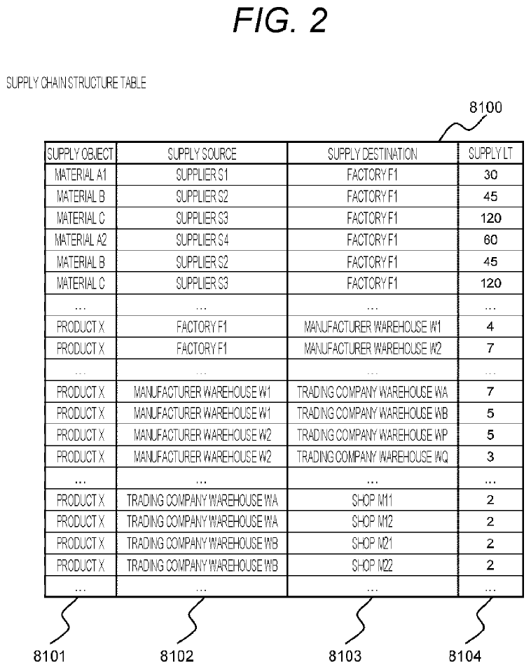

FIG. 2 is a diagram illustrating a data structure example of the supply chain structure table. The supply chain structure table 8100 includes four fields of a supply object 8101, a supply source 8102, a supply destination 8103, and a supply LT 8104. The fields are associated with each other. The supply object 8101 includes information for specifying a product or a material thereof. The supply source 8102 includes information for specifying an entity, a company, or the like that supplies the material or the product specified by the supply object 8101 onto the supply chain structure. The supply destination 8103 includes information for specifying an entity, a company, or the like that receives the material or the product specified by the supply object 8101 from the entity specified by the supply source 8102 on the supply chain structure. The supply LT 8104 includes information for specifying a supply lead time in each supply path.

That is, it can be said that the supply chain structure table 8100 accumulates supply path information indicating which supply object (product and material) is supplied from which supply source to which supply destination, and supply lead time information in each supply path. Note that a unit of the supply lead time is desirably matched with a minimum unit handled on a sales date of the sales record data table 8300 to be described later and a time bucket handled by the demand prediction calculation unit 4000.

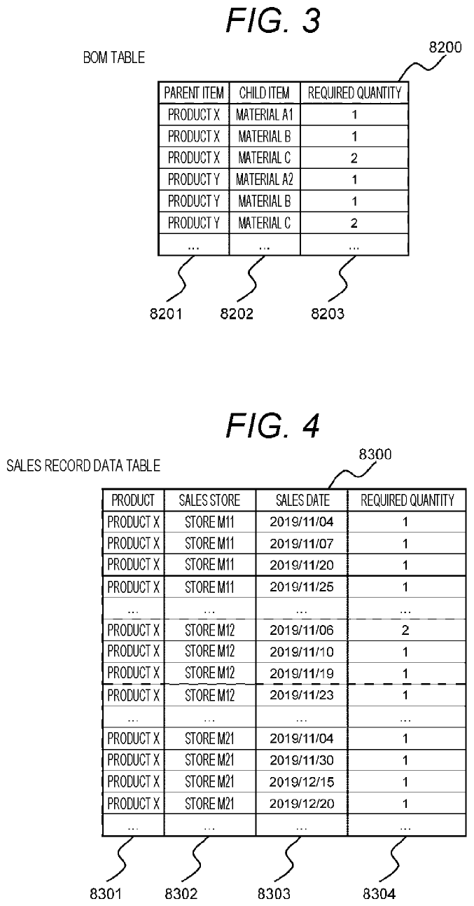

FIG. 3 is a diagram illustrating a data structure example of the BOM table. The BOM table 8200 includes three fields of a parent item 8201, a child item 8202, and a required quantity 8203. The fields are associated with each other. The parent item 8201 includes information for specifying a product or a predetermined material (assembly) constituting the product. The child item 8202 includes information for specifying a predetermined material constituting the product or the material specified by the parent item 8201. The required quantity 8203 includes information for specifying the quantity of materials specified by the child item 8202 necessary for constituting the product or the material specified by the parent item 8201.

That is, it can be said that the BOM table 8200 accumulates information on which product (parent item) is constituted by which material (child item), and how many child items are required per parent item.

FIG. 4 is a diagram illustrating a data structure example of the sales record data table. The sales record data table 8300 includes four fields of a product 8301, a sales store 8302, a sales date 8303, and a quantity 8304. The fields are associated with each other. The product 8301 includes information for specifying the product. The sales store 8302, the sales date 8303, and the quantity 8304 each include information for specifying the sales store that sells the product specified by the product 8301, the sales date, and the quantity.

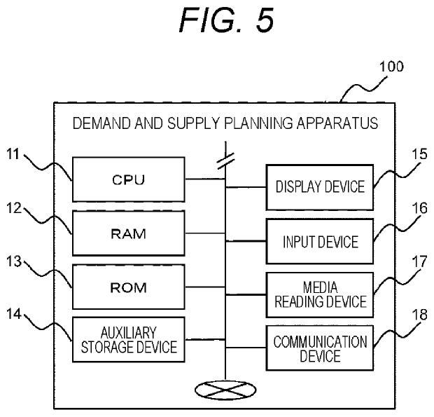

FIG. 5 is a diagram illustrating a hardware configuration example of the demand and supply planning apparatus. The demand and supply planning apparatus 100 includes a central processing unit (CPU) 11, a random access memory (RAM) 12, a read only memory (ROM) 13, an auxiliary storage device 14, a display device 15, an input device 16, a media reading device 17, and a communication device 18.

The CPU 11 is a unit that executes various calculations. The CPU 11 executes various kinds of processing by executing a predetermined program loaded from the auxiliary storage device 14 to the RAM 12.

The program is, for example, an application program that can be executed on an operating system (OS) program.

Furthermore, the application program may be installed in the auxiliary storage device 14 from a portable storage medium via the media reading device 17, for example.

The RAM 12 is a memory that stores a program executed by the CPU 11, data necessary for executing the program, and the like. The ROM 13 is a memory that stores programs and the like necessary for starting the demand and supply planning apparatus 100. The auxiliary storage device 14 is, for example, a device such as a hard disk drive (HDD). The auxiliary storage device 14 may be a solid state drive (SSD) using a flash memory or the like. Furthermore, the RAM 12 and the auxiliary storage device 14 may be handled as one storage by being assigned a virtual memory address by a technique such as a virtual memory.

The display device 15 is, for example, a device such as a CRT display, a liquid crystal display (LCD), or an organic electro-luminescence (EL) display.

The input device 16 is, for example, a device such as a keyboard, a mouse, a microphone, or a touch panel. The media reading device 17 is a device that reads information of a portable storage medium having portability, such as a CD-ROM or a digital versatile disk (DVD).

The communication device 18 is a device that transmits and receives data to and from an external device via a network. Examples thereof include devices such as a wired LAN, a wireless LAN, a dial-up router, an infrared communication device, and a Bluetooth (registered trademark) device.

For example, the supply chain structure extraction unit 1000, the product configuration extraction unit 2000, the planning unit calculation unit 3000, the demand prediction calculation unit 4000, the supply plan extraction unit 5000, and the supply plan communication unit 6000 can be implemented by loading a predetermined program stored in the auxiliary storage device 14 into the RAM 12 and executing the program by the CPU 11, the input and output reception unit 7500 can be implemented by the CPU 11 using the input device 16 and the display device 15, the communication unit 7000 can be implemented by the CPU 11 using the communication device 18, and the data storage unit 8000 can be implemented by the processor 11 using the RAM 12 or the auxiliary storage device 14.

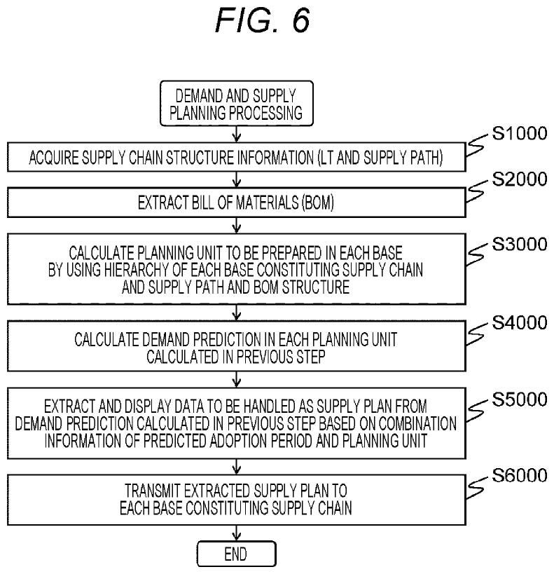

FIG. 6 is a diagram illustrating an example of a flow of demand and supply planning processing. The demand and supply planning processing is started at a predetermined time (for example, every day) or when an instruction to start processing is given to the demand and supply planning apparatus 100.

First, the supply chain structure extraction unit 1000 acquires supply chain structure information (lead time and supply path) (step S1000). Specifically, the supply chain structure extraction unit 1000 accesses a server apparatus of each company constituting the supply chain via the communication unit 7000, and acquires supply chain structure information including a transportation lead time between the companies constituting the supply chain, a supply path of materials and products, and information of companies that perform material production and product assembly. The information acquired herein is stored in the supply chain structure table 8100 of the data storage unit 8000.

Subsequently, the product configuration extraction unit 2000 extracts a bill of materials (BOM) (step S2000). Specifically, the product configuration extraction unit 2000 accesses the server apparatus of each company constituting the supply chain via the communication unit 7000, and extracts information on a bill of materials (BOM) of products or materials handled by each company. The information acquired herein is stored in the BOM table 8200 of the data storage unit 8000.

Subsequently, the planning unit calculation unit 3000 calculates a planning unit to be prepared in each base by using a hierarchy within the supply chain of the base of each company constituting the supply chain and the supply path and the BOM structure (step S3000). Specifically, the planning unit calculation unit 3000 performs a planning unit calculation processing to be described later. Note that the planning unit means a combination of products handled by the entity on the supply chain structure, but is not limited thereto. When there is a direct delivery path (supply path) from a manufacturer to a sales store, or the like, it is desirable to handle the direct delivery path as the planning unit.

The demand prediction calculation unit 4000 calculates a demand prediction for each of the planning units calculated in step S3000 (step S4000). Specifically, the demand prediction calculation unit 4000 calculates the demand prediction for each of the planning units calculated by the planning unit calculation unit 3000 by using the sales record information acquired via communication with the company that sells the product to the end customer provided by the communication unit 7000.

A known algorithm can be adopted as an algorithm of the demand prediction. For example, in this processing, the demand prediction calculation unit 4000 adds sales records in the sales record data table 8300 of the data storage unit 8000 in each planning unit calculated in step S3000, and predicts the demand ahead for each time-series data. The demand prediction data may be generated by using a demand prediction method of the related art such as a moving average method, an exponential smoothing method, or a time series analysis method using an autoregressive sum moving average (ARIMA) model, or may be calculated by applying other demand prediction methods. Furthermore, a specific demand prediction method may be applied to all the planning units, or a different demand prediction method may be applied to each planning unit. Furthermore, for example, a learned model that outputs demand in a predetermined planning unit based on the sales records may be used.

The supply plan extraction unit 5000 extracts and displays data to be handled as a supply plan from the demand prediction calculated in step S4000 based on the combination information of the predicted adoption period and the planning unit calculated in step S3000 (step S5000).

Note that the predicted adoption period is a target period requiring a demand prediction, and refers to a period between a point in time at which the supply chain structure is traced back by the lead time from a downstream side and a time elapsed point in time of a maximum width of the lead time from an entity of an immediate upstream. Furthermore, data to be handled as the supply plan is data for extracting a demand of each entity from the demand prediction according to the lead time.

For example, when the predicted adoption period is 30 days to 60 days and the planning unit is the market range (sales channel to end customer (or set thereof))={M11, M12} and a set of end products={X} in a certain company C, a value from 30 days ahead to 60 days ahead of the demand prediction values calculated based on a total demand value of an item of X in two bases of a store M11 and a store M12 is extracted as the supply plan of the company C.

The supply plan communication unit 6000 transmits the extracted supply plan to each base constituting the supply chain (step S6000).

The above description is an example of the flow of the demand and supply planning processing. According to the demand and supply planning processing, it is possible to output an appropriate supply plan in which the demand prediction in each planning unit can be calculated based on the planning unit of the demand to be prepared by each company constituting the supply chain and each company can adopt necessary and sufficient demand prediction data. Thus, it is possible to prepare an efficient demand plan in the entire supply chain from the top down, and it is possible to improve the overall efficiency.

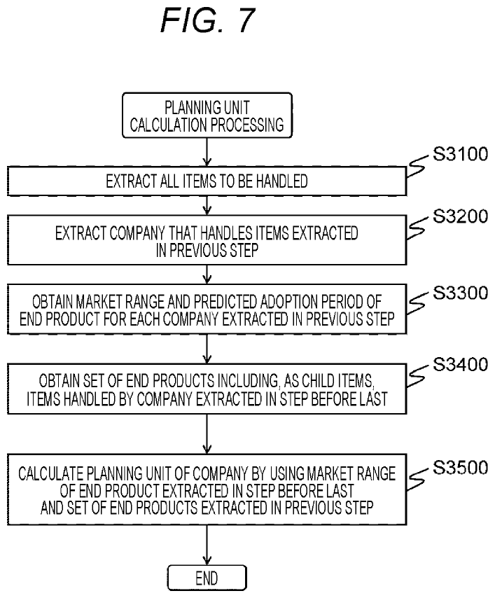

FIG. 7 is a diagram illustrating an example of a flow of planning unit calculation processing. The planning unit calculation processing is started within the processing of step S3000 of the demand and supply planning processing.

First, the planning unit calculation unit 3000 extracts all items handled in the supply chain (step S3100). The contents of this processing will be described in detail in handled-item extraction processing to be described later.

The planning unit calculation unit 3000 extracts a company that handles the item extracted in step S3100 (step S3200). This processing is implemented by extracting a record in which an item to be handled is included in the supply object 8101 in the supply chain structure table 8100 and extracting a list of the supply sources 8102.

Subsequently, the planning unit calculation unit 3000 obtains the market range and the predicted adoption period of the end product for each of the companies extracted in step S3200 (step S3300). The contents of this processing will be described in detail in supply lead time calculation processing to be described later.

The planning unit calculation unit 3000 obtains a set of end products including the items handled by the company extracted in step S3200 as the child items (materials) (step S3400). In this processing, the planning unit calculation unit 3000 can calculate the set by performing an inductive search on the BOM table 8200 of the data storage unit 8000.

Subsequently, the planning unit calculation unit 3000 calculates the planning unit of the company by using the market range of the end product extracted in step S3300 and the set of end products extracted in step S3400 (step S3500). For example, when the market range of the end product extracted in step S3300 is {M11, M12} and the set of the end products extracted in step S3400 is {X}, the planning unit of the company can be calculated to be the total demand value of the items of X at two bases of M11 and M12.

The above description is an example of the flow of the planning unit calculation processing. According to the planning unit calculation processing, it is possible to calculate a planning unit to be prepared in each base by using a hierarchy in the supply chain of the base of each company constituting the supply chain and the supply path and the BOM structure.

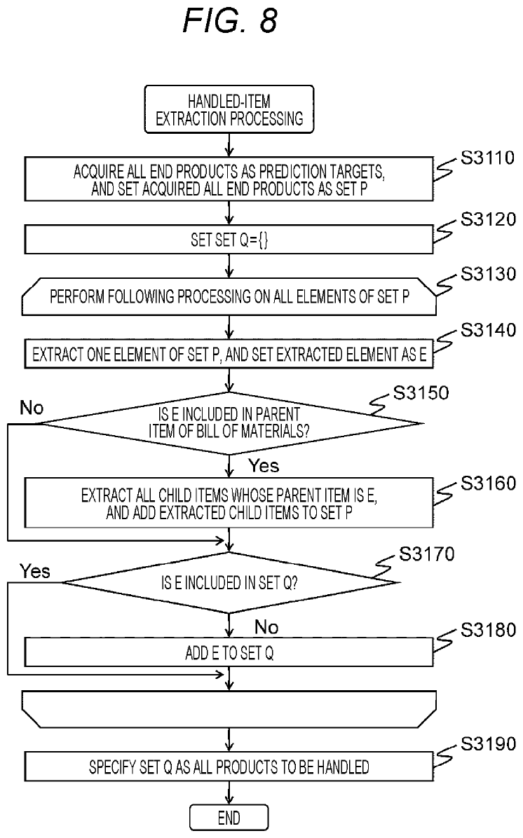

FIG. 8 is a diagram illustrating an example of a flow of the handled-item extraction processing. The handled-item extraction processing is started within the processing of step S3100 of the planning unit calculation processing.

First, the planning unit calculation unit 3000 acquires all the end products that can be prediction targets in the demand and supply planning apparatus 100, and sets the end products as a set P (step S3110). In this processing, the planning unit calculation unit 3000 may receive designation of the set P of end products from a user in advance via the input and output reception unit 7500, or may automatically extract the set P from an item master (not illustrated) stored in the data storage unit 8000.

The planning unit calculation unit 3000 sets a set Q as an empty set (Q={ }) (step S3120). Thereafter, the planning unit calculation unit 3000 repeatedly performs the processing of steps S3140 to S3180 on all elements of the set P, that is, all the end products (step S3130).

The planning unit calculation unit 3000 extracts one element from the set P and sets the extracted element as E (S3140). The planning unit calculation unit 3000 determines whether or not E is a product included in any one of the parent items 8201 of the bill of materials, that is, the BOM table 8200 (step S3150). When E is not included in the parent item of the bill of materials (“No” in step S3150), the planning unit calculation unit 3000 advances the control to step S3170.

When E is included in the parent item in the bill of materials (“Yes” in step S3150), the planning unit calculation unit 3000 extracts all child items whose parent item corresponds to E and adds the child items to the set P (step S3160). That is, the planning unit calculation unit 3000 adds all the child materials included in E to the set P and sets an entry as a target for determining whether or not the child materials are included in the product to be handled.

The planning unit calculation unit 3000 determines whether or not E is included in the set Q (step S3170). When E is included in the set Q (“Yes” in step S3170), the planning unit calculation unit 3000 advances the control to step S3150.

When E is not included in the set Q (“No” in step S3170), the planning unit calculation unit 3000 adds E to the set Q (step S3180). That is, the planning unit calculation unit 3000 adds E to the set Q of products to be handled and sets an entry as a target for determining whether or not E is included in the products to be handled.

The planning unit calculation unit 3000 specifies the set Q obtained as a result of performing the above processing as all the products to be handled (step S3190).

The above description is an example of the flow of the handled-item extraction processing. According to the handled-item extraction processing, all the items handled in the supply chain can be extracted.

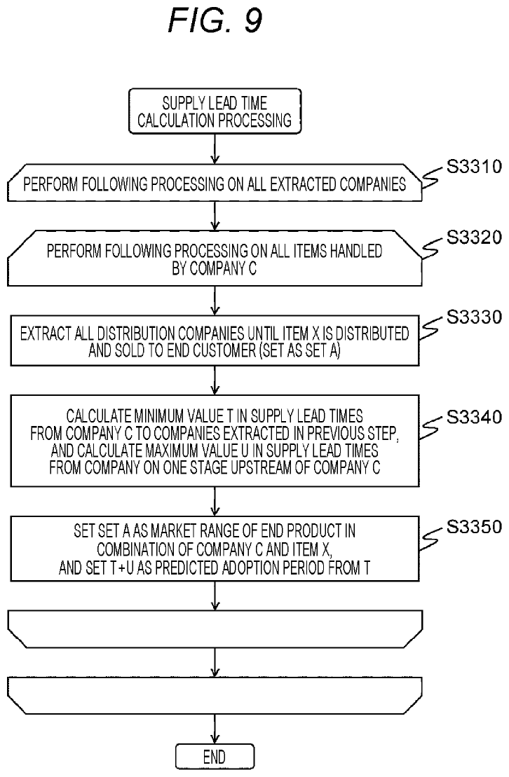

FIG. 9 is a diagram illustrating an example of a flow of supply lead time calculation processing. The supply lead time calculation processing is started within the processing of step S3300 of the planning unit calculation processing.

First, the planning unit calculation unit 3000 performs the processing of steps S3320 to S3350 on all the extracted companies (step S3310). The planning unit calculation unit 3000 performs the processing of steps S3330 to S3350 on all the extracted items handled by the company C (step S3320).

The planning unit calculation unit 3000 extracts all distribution companies from when the target item X is distributed to when the target item is sold to the end customer, and sets the extracted distribution companies as a set A (step S3330). Specifically, the planning unit calculation unit 3000 can extract the set A by extracting a record in which the target item X and the company C coincides with the supply object 8101 and the supply source 8102, respectively, from the supply chain structure table 8100, setting a value of the supply destination 8103 of the record as a new company C, and inductively searching the supply chain structure table 8100.

The planning unit calculation unit 3000 calculates a minimum value T among the supply lead times from the company C to each company extracted in step S3330, and a maximum value U among the supply lead times from a company on one stage upstream of the company C (entity that provides materials or products to the company C) (step S3340). In the calculation processing of the value T, the planning unit calculation unit 3000 adds a value of the supply LT 8104 of the supply chain structure table 8100 in the inductive search in step S3330, and sets a minimum value thereof as T. Furthermore, in the calculation processing of the value U, the planning unit calculation unit 3000 extracts a record in which the supply destination 8103 of the supply chain structure table 8100 coincides with the company C, and the value of the supply LT 8104 is maximized.

The planning unit calculation unit 3000 sets the set A extracted in step S3330 as the market range of the end product in a combination of the company C and the item X, and sets T+U from the minimum value T of the supply lead time calculated in step S3340 as the predicted adoption period (step S3350).

The above description is an example of the flow of the supply lead time calculation processing. According to the supply lead time calculation processing, the market range and the predicted adoption period of the end product can be obtained for each company extracted in step S3200.

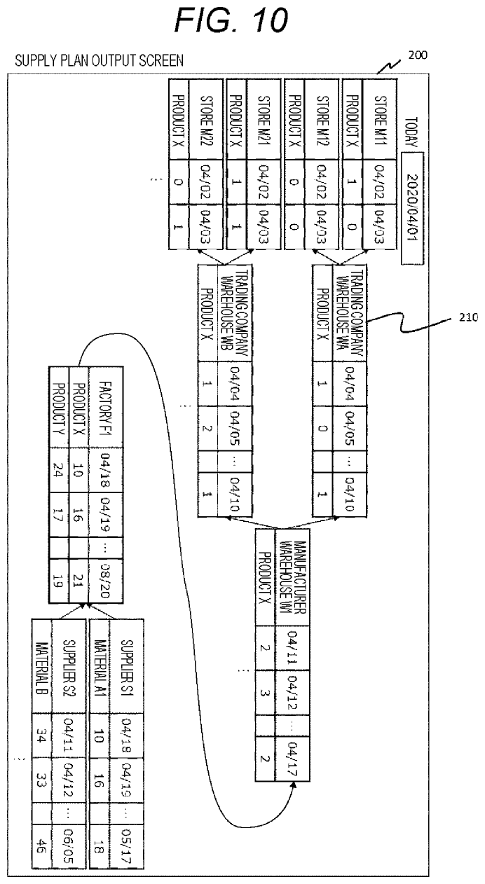

FIG. 10 is a diagram illustrating an example of a supply plan output screen. A supply plan output screen 200 is a screen example in which the supply plan extracted in step S5000 is extracted. For example, a trading company warehouse WA 210 in FIG. 10 illustrates a case where the predicted adoption period is 3 to 9 days, the market range={M11, M12}, and the set of end products={X}.

In FIG. 10, assuming that today's date is 2020/4/1, supply plan values of 4/4 to 4/10 to which the predicted adoption period in the trading company warehouse WA 210 is added are displayed.

The above description is the configuration of the demand and supply planning apparatus according to the present embodiment. According to the demand and supply planning apparatus 100 according to the present embodiment, it is possible to output an appropriate supply plan in which the demand prediction in each planning unit can be calculated based on the planning unit of the demand to be prepared by each company, which can be calculated from the supply chain structure, and each company can adopt necessary and sufficient demand prediction data.

The present invention is not limited to the aforementioned embodiments, and includes various modification examples. For example, in the above embodiment, the supply plan extraction unit 5000 can perform the demand prediction that is optimal as a whole when there is no problem. However, the supply plan extraction unit 5000 may set the supply plan by calculating, as a new supply plan value, a result of performing reception and payment calculation by using a value of inventory reference of each base from the extracted value of the supply plan and by reflecting the inventory reference of each base. In general, this processing is processing of adapting that companies located in distribution destinations on the supply chain structure from the company usually have inventory plans to deal with supply and demand variation factors. Since an increase or a decrease of the inventory plan affects an order quantity received by the company, a plan with higher expected implementation can be obtained by adopting a value obtained by adding or subtracting the increase or decrease of the inventory plan to and from the demand prediction obtained previously as a value to be set as the supply plan of the company.

Furthermore, for example, the aforementioned embodiment is described in detail in order to facilitate easy understanding of the present invention, and is not limited to necessarily include all the described components. Furthermore, some of the components of a certain embodiment can be substituted into the components of another embodiment, and the components of another embodiment can be added to the component of a certain embodiment. Furthermore, another component can be added, removed, and substituted to, from, and into some of the components of the aforementioned embodiment.

Furthermore, a part or all of the aforementioned configurations, functions, processing units, and processing means may be implemented by hardware by being designed with an integrated circuit, for example. Furthermore, each of the aforementioned configurations and functions may be realized by software by interpreting and executing a program that implements each function by the processor. Information of programs, tables, and files for achieving the functions can be stored in a recording device such as a memory, a hard disk, or an SSD, or a recording medium such as an integrated circuit (IC) card, an SD card, or a DVD.

Furthermore, control lines and information lines illustrate lines which are considered to be necessary for the description, and not all the control lines and information lines in a product are necessarily illustrated. Almost all the configurations may be considered to be actually connected to each other. Hereinabove, the present invention has been described focusing on the embodiments.

### REFERENCE SIGNS LIST

100 demand and supply planning apparatus
1000 supply chain structure extraction unit
2000 product configuration extraction unit
3000 planning unit calculation unit
4000 demand prediction calculation unit
5000 supply plan extraction unit
6000 supply plan communication unit
7000 communication unit
7500 input and output reception unit
8000 data storage unit
8100 supply chain structure table
8200 BOM table
8300 sales record data table

1. A demand and supply planning apparatus, comprising:
a supply chain structure extraction unit that specifies a lead time between bases having different business entities in a supply chain structure and supply paths of products and materials of the products;
a product configuration extraction unit that extracts a bill of materials (BOM) of the product;
a planning unit calculation unit that calculates a planning unit in which a demand prediction is to be prepared by using any one or a combination of positions of the bases within the supply chain structure, the supply paths, and the bill of materials;
a demand prediction calculation unit that calculates the demand prediction for each panning unit calculated by the planning unit calculation unit;
a supply plan extraction unit that extracts data to be handled as a supply plan for each base from the demand prediction in accordance with the lead time and the planning unit; and
a supply plan communication unit that transmits the extracted supply plan to each base or each business entity.

2. The demand and supply planning apparatus according to claim 1, wherein the planning unit calculation unit specifies a market range formed by tracing back the supply path starting from a base that sells the products to an end customer in the supply chain structure by using the combination of the positions of the bases within the supply chain structure, the supply paths, and the bill of materials, and calculates the planning unit in accordance with a predicted adoption period specified by using the market range, a set of the products supplied by the base that sells the products to the end customer, and the supply chain structure.

3. The demand and supply planning apparatus according to claim 1, wherein the supply plan extraction unit sets the supply plan by calculating, as a new supply plan value, a result of performing reception and payment calculation by using a value of an inventory reference of the base from a value of the extracted supply plan and by reflecting the inventory reference of each base.

4. The demand and supply planning apparatus according to claim 1, wherein
the base includes any one or a combination of one or a plurality of factories that manufactures the products by using the materials, one or a plurality of suppliers that supplies the products to any one of the factories, and one or a plurality of real stores or virtual stores that sells the products to an end customer, and
the demand prediction calculation unit performs the demand prediction by using sales records in the real store and the virtual store for each planning unit.

5. A demand and supply planning method using a demand and supply planning apparatus, wherein
the demand and supply panning apparatus includes a processor, and
the processor performs
a supply chain structure extraction step of specifying a lead time between bases having different business entities in a supply chain structure and supply paths of products and materials of the products,
a product configuration extraction step of extracting a bill of materials of the product,
a planning unit calculation step of calculating a planning unit in which a demand prediction is to be prepared by using any one or a combination of positions of the bases within the supply chain structure, the supply paths, and the bill of materials,
a demand prediction calculation step of calculating the demand prediction for each panning unit calculated in the planning unit calculation step,
a supply plan extraction step of extracting data to be handled as a supply plan for each base from the demand prediction in accordance with the lead time and the planning unit, and
a supply plan communication step of transmitting the extracted supply plan to each base or each business entity.

6. A demand and supply planning system including a supply and demand planning apparatus, wherein
the demand and supply planning apparatus includes:
a supply chain structure extraction unit that specifies a lead time between bases having different business entities in a supply chain structure and supply paths of products and materials of the products, the lead time and the supply paths being acquired by communicating with another device provided by the business entity via a network;
a product configuration extraction unit that extracts a bill of materials (BOM) of the product, the bill of materials being acquired by communicating with the other device provided by the business entity via the network;
a planning unit calculation unit that calculates a planning unit in which a demand prediction is to be prepared by using any one or a combination of positions of the bases within the supply chain structure, the supply paths, and the bill of materials;
a demand prediction calculation unit that calculates the demand prediction for each panning unit calculated by the planning unit calculation unit;
a supply plan extraction unit that extracts data to be handled as a supply plan for each base from the demand prediction in accordance with the lead time and the planning unit; and
a supply plan communication unit that transmits, via the network, the extracted supply plan to each base or each business entity.
